(19) United States
(12) Patent Application Publication
(10) Pub. No.: US 2015/0261607 A1
(43) Pub. Date: Sep. 17, 2015

(54) Enhanced security for offsite data storage

(71) Applicant: Karl Christopher Hansen, Concord, NH (US)

(72) Inventor: Karl Christopher Hansen, Concord, NH (US)

(21) Appl. No.: 14/658,013

(22) Filed: Mar. 13, 2015

Related U.S. Application Data
(60) Provisional application No. 61/952,181, filed on Mar. 13, 2014.

(51) Int. Cl. G06F 11/10; H04L 29/08

(52) U.S. Cl. CPC G06F 11/1076; H04L 67/1097

(57) ABSTRACT

Systems and methods for enhancing security, reliability, and availability of data stored on distributed systems using error-correction codes and N-choose-M error recovery, where no single storage system contains a recoverable portion of the data. The systems and methods are particularly suited for mitigating the risk of loss or compromise of data stored on Cloud Storage systems and for securely storing critical information such as credit-card information, medical data, financial information, etc.

### TECHNICAL FIELD

The present disclosure relates to systems and methods for distributed data storage to enhance reliability, security, catastrophic recovery, and to reduce likelihood of theft or loss of data.

### BACKGROUND

Technology has for several years allowed use of error-correction techniques and redundant disk arrays to be used so that lost subsets of data can be recovered from the remaining data. Network storage often uses redundancy and RAID techniques for increased data safety, allowing failure of a drive to have minimal impact on operations. The following links describe some commonly used approaches:

http://en.wikipedia.org/wiki/Error_detection_and_correction
http://www.computerweekly.com/podcast/Examining-RAID-
levels-RAID-0-through-RAID-6
http://searchstorage.techtarget.com/tip/RAID-6-vs-RAID-10

Recently the development of “cloud storage” has made “offsite backup” easy for companies and individuals. Many companies offer cloud-based storage repositories with capacities into the terabytes and more. Cloud storage has been a field of huge growth, and the ease of use makes it likely that it will continue to experience high growth as more and more companies and individuals turn to it for their ever-growing data storage requirements.

In addition, many companies (e.g. Amazon, E-Bay) recognize the advantage of storing copious amounts of data about processes, customers, transactions, and more, with the goal of “data mining” to detect patterns and trends which may not be obvious without the availability of large datasets across significant spans of time. These repositories are considered very confidential by companies which collect them, and their loss or compromise would be detrimental to both the companies and their customers. Recent history has many examples of companies who have had loss or compromise of repositories containing credit card data, and personal and confidential information.

Cloud storage offers the potential for offsite backups of even massive amounts of data, and most cloud storage providers use secure communication protocols and password-protected user repositories for access.

Unfortunately cloud storage exposes users to loss of data if the cloud they chose for holding their data goes bankrupt, or suffers catastrophic failure. Users can also experience compromise of their repositories if the cloud uses poor or out-of-date security protocols (e.g. OpenSSL “Heartbleed” bug), is penetrated by hackers, or has systems subverted by employees, or if system deficiencies such as hardware or software problems expose or leak user data. The Gartner research firm recently forecast that 25% of cloud storage companies will disappear by the end of 2015. Symantec once offered a cloud-based backup solution, but has pulled it from the market. Nirvanix and Megacloud, both cloud storage providers, collapsed in recent years. Nirvanix was partnered with IBM, showing that even well-connected firms can experience problems. The following links provide information on these and similar issues:

http://en.wikipedia.org/wiki/Heartbleed
http://www.extremetech.com/computing/114803-
megauploads-demise-what-happens-to-
your-files-when-a-cloud-service-dies
http://www.networkworld.com/article/2173255/
cloud-computing/cloud-s-worst-case-scenario-
what-to-do-if-your-provider-goes-belly-up.html
http://www.computerworld.com/article/2486691/
cloud-computing/one-in-four-cloud-
providers-will-be-gone-by-2015.html

As such, the present disclosure recognizes a need to enhance reliability, security, catastrophic recoverability, and to reduce likelihood of theft or loss of stored data.

### SUMMARY

In one embodiment, a method according to the present disclosure includes utilizing two or more unique cloud storage repositories as a “virtual cloud repository”, adding error correction information (ECC and/or FEC, e.g. convolutional, Reed-Muller, Reed-Solomon, Reed-Solomon-Viterbi, etc.) to the data, and storing the resulting data in the virtual cloud repository in such a manner that no single cloud storage repository has a complete set of the original data.

Embodiments according to the present disclosure may also include a system for encrypting the original data (with or without ECC) and partitioning the encrypted data using an error- correction system using “N-choose-M” error recovery, where there M<=N, data is split into N partitions, with no partition in N containing a recoverable portion of the original data, and the complete set of encrypted data plus error correction data can be recovered from any subset M of the N partitions, and storing each partition in a unique cloud storage repository. Partitioning can occur at word, byte, or even bit levels.

In other embodiments, a method for enhancing security and recoverability includes using multiple unique cloud storage repositories as virtual disk drives in a RAID configuration, such as RAID5, RAID6, etc., where no single repository contains a recoverable portion of the data, but the data may be recovered using combinations of the remaining repositories.

In one embodiment, a method for enhancing security and recoverability according to the present disclosure includes dynamically changing the partitioning bins for a given set of data on a bit-by-bit, byte-by-byte, or chunk-by-chunk basis so that no single repository contains a contiguous block of data from the original data. This adds a layer of obfuscation to the data recovery so that not only must one be able to recover all of the original bits across all of the repositories, but be able to un-bin the data to restore the proper order of the original data before it can be used or understood.

In other embodiments, a method for enhancing security and recoverability includes dynamically time-multiplexing the upload and/or download of fragments of partitioned data so that any possible line taps cannot recover a contiguous bit stream of the original full layout of all partitions without knowing the dynamic sequencing of the fragments.

In one embodiment, various network-attached-storage systems located in N different geographic areas are used as the distributed storage repositories, enabling a distributed catastrophic recovery system mitigating destruction or loss of up to (N-M) systems without loss of data. Each of the N distributed storage repositories acts as both a repository for 1/N of the data and a data access point for the remaining data.

In other embodiments, a method for enhancing security and recoverability includes upload and/or download of fragments of partitioned data simultaneously via parallel independent channels, for example, parallel fiber-optic and RF channels, or multiple fiber-optic cables from different carriers, so that any possible line taps cannot recover any complete partition from the content of a single channel. In related embodiments, the number of parallel channels is based on a similar N-choose-M ECC recovery system used for storage of the data, such that the set of bits being transmitted in a given timeframe can be recovered from any subset M of the original N subsets of bits transmitted during that timeframe.

In various integrated circuit embodiments, systems or methods according to the present disclosure may include computation of the ECC, encryption, partitioning, time-multiplexing of transmit/receive of partition fragments, and/or parallel transmit/receive over independent channels.

Various embodiments according to the present disclosure may provide a number of advantages. For example, systems and methods according to the present disclosure facilitate improved recoverability for distributed data storage. The complete data image may be recovered from any subset M of the selected N offsite repositories, eliminating the impact of provider bankruptcies or catastrophic failures. Various embodiments according to the present disclosure may provide improved security for distributed data storage. Any penetration or theft of up to (N-M) partitions leaves the perpetrator(s) unable to replicate the original data image. Without knowledge of the dynamic re-binning method used on the original data image, even if a perpetrator obtains M or more of the partitions they must still un-bin the partitions correctly. Combined with encryption of the data, together with use of the disclosed systems or methods to distribute the encryption/decryption keys across distributed repositories, the likelihood of data loss or compromise becomes vanishingly small.

Embodiments according to the present disclosure address the need for enhanced recoverability and security for distributed data storage. Using various embodiments according to the present disclosure mitigate the risks associated with use of cloud storage for backup of critical, confidential, and/or valuable information.

### BRIEF DESCRIPTION OF THE DRAWINGS

FIG. 1 illustrates a system accessing local data from a computer and/or smart phone and distributed repositories arranged similarly to a RAID6 disk configuration;

FIGS. 2A and 2B illustrate operation of a system or method for storing (2A) and recovery (2B) of data on distributed repositories;

FIG. 3 illustrates a system using six distributed computers or servers as simultaneous repositories and consumers of the data.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

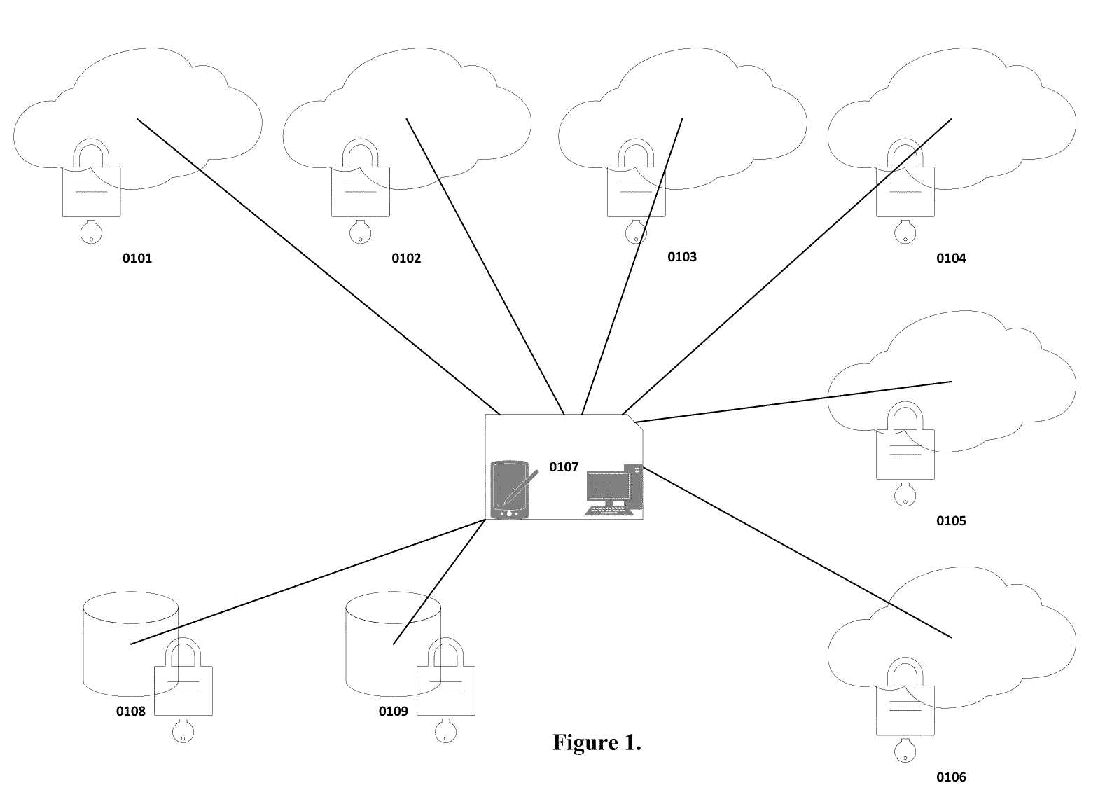

FIG. 1 illustrates a representative system configured to behave similarly to a RAID6 disk array. 0101 through 0106 represent six unique distributed repositories with repository-specific security represented by the locks and keys. 0108 and 0109 represent local stored data which may or may not be local images of the data stored on the distributed repositories. 0107 represents a system with any or all of computers, smart phones, PDAs, etc., which access data locally from 0108 and 0109, or from the distributed repositories 0101-0106, or both. 0107 manages the store and transfer configuration, and replication/verification of data between local and distributed repositories.

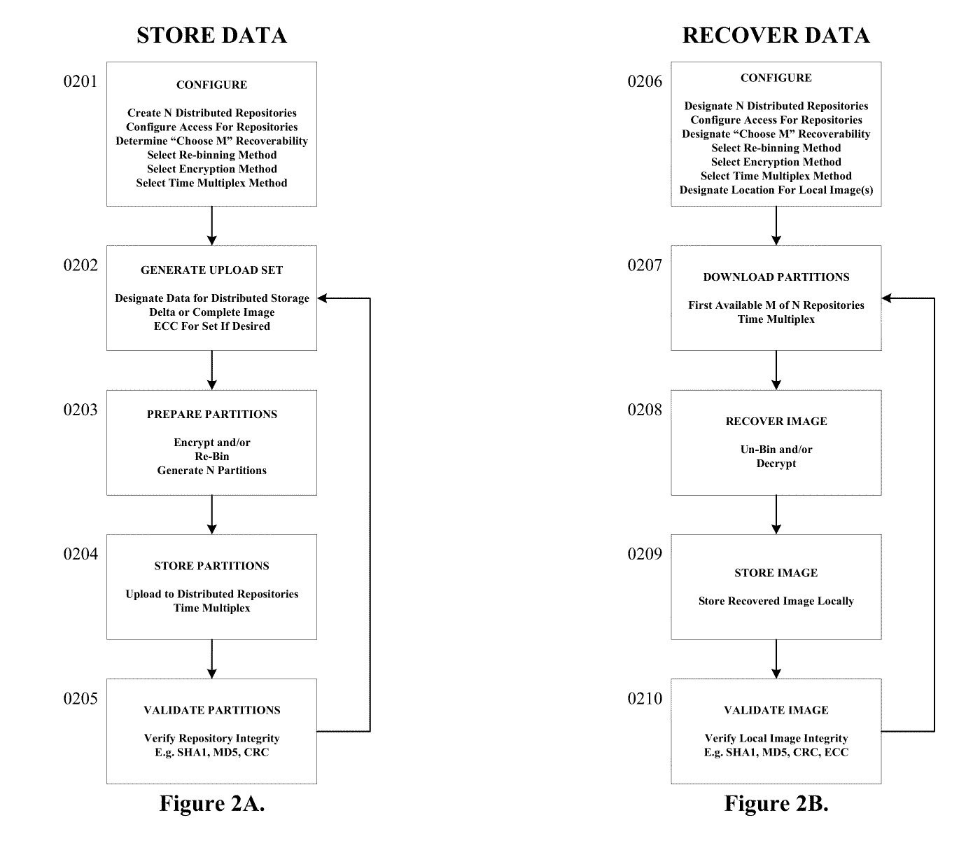

FIGS. 2A and 2B illustrate operation of various representative embodiments of a system or method according to the present disclosure, for storage (2A) and recovery (2B) of data. Those of ordinary skill in the art will recognize that the functions represented in the diagrams may be performed by various types of devices, including software, firmware, and/or hardware devices. Depending upon the particular application and implementation, various functions may be performed by circuitry implemented using discrete components and/or integrated circuit components. As such, the various functions may be performed in an order or sequence other than illustrated in the Figures. Similarly, one or more steps or functions may be repeatedly performed, or omitted, although not explicitly illustrated. Furthermore, those of ordinary skill in the art will recognize that DATA, whether stored or recovered, can be an entire aggregate whole or small subsets of the whole without loss of capability or generality.

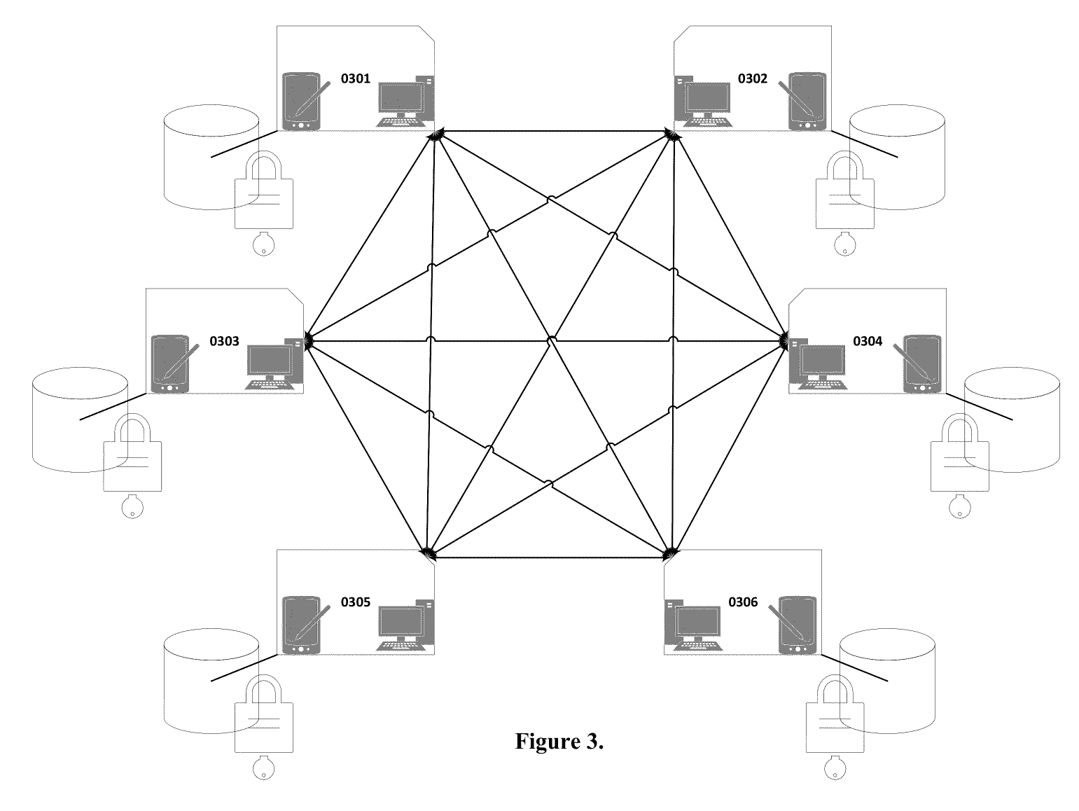

FIG. 3 illustrates a group of six distributed systems each acting as both a distributed repository and as a consumer of the overall data. Each system (0301-0306) serves up ⅙ of the distributed data, and consumes information from the whole of the distributed data. Information not stored locally is retrieved from the appropriate remote system as needed. Those of ordinary skill in the art will recognize that the bandwidth at any given system is reduced below that required for the typical complete-image redundant backup approaches. Those of ordinary skill in the art will also recognize that the keys for encrypting/decrypting and re-binning/multiplexing maps for the information is itself data which can be securely and reliably stored across distributed repositories without fear of any single point of failure or penetration compromising recovery of those keys and maps for recovery of the remaining data.

As can be seen by the embodiments illustrated and described above, systems and methods for enhanced reliability, security, and recoverability, according to the present disclosure may provide a number of advantages and facilitate a substantial improvement in reliability, security, and recoverability while also accruing a reduction in required bandwidth for access and maintenance of the overall set of data.

Embodiments such as these and other systems and methods according to the present disclosure will enable secure storage of credit-card information, medical data, corporate secrets, financial data, and more while mitigating the possible compromise or loss of such information through theft/destruction by hackers or disgruntled employees, catastrophic loss of backups, etc.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention. Similarly, while the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

What is claimed is:

1. A method for securing digital data stored in distributed repositories, comprising:
separating the digital data into a plurality of portions with no portion having more than a predetermined amount of sequential data,
storing each of the plurality of portions on a different distributed repository.

2. The method of claim 1 further comprising:
using N portions in the plurality of portions,
generating error correction information for the digital data such that only M of the plurality of portions is required to recover the original digital data, where M<N,
including the error correction information as part of the digital data before it is separated into portions.

3. A method for recovering securely stored digital data stored in distributed repositories, comprising:
retrieving a plurality of portions from distributed repositories,
combining the plurality of portions to recreate the digital data.

4. The method of claim 3 further comprising:
having digital data containing generated error correction code stored in N portions such that M of N portions are required to recover all of the digital data,
retrieving at least M portions from distributed repositories,
recreating the digital data from the at least M portions.

5. A system for storing digital data across multiple distributed repositories comprising:
circuitry and/or sub-systems which re-bin and separate the digital data into a plurality of portions with no portion having more than a predetermined amount of sequential bits from the digital data,
one or more communication channels for exchanging subsets of each of the plurality of portions with each of the multiple distributed repositories.

6. The system of claim 5 further comprising:
peer-to-peer networks where the distributed repositories include one or more computing devices and/or servers.

7. The system of claim 5 further comprising:
networks where the distributed repositories include one or more Cloud Storage accounts.

8. The system of claim 5 further comprising:
networks where the distributed repositories include one or more network attached storage devices.

9. The system of claim 5 further comprising:
networks where the distributed repositories include one or more IoT-based storage devices.

10. The system of claim 5 further comprising:
networks where the distributed repositories are media devices and/or servers.
